(19) United States
(12) Patent Application Publication
(10) Pub. No.: US 2010/0115510 A1
(43) Pub. Date: May 6, 2010

(54) VIRTUAL GRAPHICS DEVICE AND METHODS THEREOF

(75) Inventors: Jeremy M. Ford, Spring, TX (US); Fahd B. Pirzada, Austin, TX (US)

Correspondence Address: LARSON NEWMAN & ABEL, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 12/263,699

(22) Filed: Nov. 3, 2008

(51) Int. Cl. G06F 9/455

(52) U.S. Cl. 718/1

(57) ABSTRACT

An information handling system is disclosed that is configured to execute multiple virtual machines simultaneously. The information handling system can assign graphical processing resources to each virtual machine based on the estimated workload for each machine. In addition, the information handling system can change the amount of graphical resources assigned to each virtual machine in response to changing workload estimations.

### FIELD OF THE DISCLOSURE

This disclosure relates generally to information handling systems, and more particularly to virtual machines for information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements can vary between different applications, information handling systems can also vary regarding what information is handled, how the information is handled, how much information is processed, stored, or communicated, and how quickly and efficiently the information can be processed, stored, or communicated. The variations in information handling systems allow for information handling systems to be general or configured for a specific user or specific use such as financial transaction processing, airline reservations, enterprise data storage, or global communications. In addition, information handling systems can include a variety of hardware and software components that can be configured to process, store, and communicate information and can include one or more computer systems, data storage systems, and networking systems.

To enhance system flexibility, an information handling system can employ virtual machines, whereby each virtual machine can be tailored for a particular use, configuration, or system environment. A virtual machine manager (VMM), such as a hypervisor, provides an interface between the virtual machines and system hardware. However, it can be difficult for the VMM to efficiently assign system resources to each virtual machine.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of a communication network in accordance with one embodiment of the present disclosure.

FIG. 2 illustrates a block diagram of the client device of FIG. 1 in accordance with one embodiment of the present disclosure.

FIG. 3 illustrates a block diagram showing additional details of the client device of FIG. 2 in accordance with one embodiment of the present disclosure.

FIG. 4 illustrates a block diagram of the framebuffer of FIG. 2 in accordance with one embodiment of the present disclosure.

FIG. 5 illustrates a diagram depicting assignment of processor resources at the client device of FIG. 2 in accordance with one embodiment of the present disclosure.

FIG. 6 illustrates a flow diagram of a method of assigning graphical resources to a set of virtual machines in accordance with one embodiment of the present disclosure.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application. The teachings can also be utilized in other applications and with several different types of architectures such as distributed computing architectures, client/server architectures, or middleware server architectures and associated components.

For purposes of this disclosure, an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system can be a personal computer, a PDA, a consumer electronic device, a network server or storage device, a switch router, wireless router, or other network communication device, or any other suitable device and can vary in size, shape, performance, functionality, and price. The information handling system can include memory, one or more processing resources such as a central processing unit (CPU) or hardware or software control logic. Additional components of the information handling system can include one or more storage devices, one or more communications ports for communicating with external devices as well as various input and output (I/O) devices, such as a keyboard, a mouse, and a video display. The information handling system can also include one or more buses operable to transmit communications between the various hardware components.

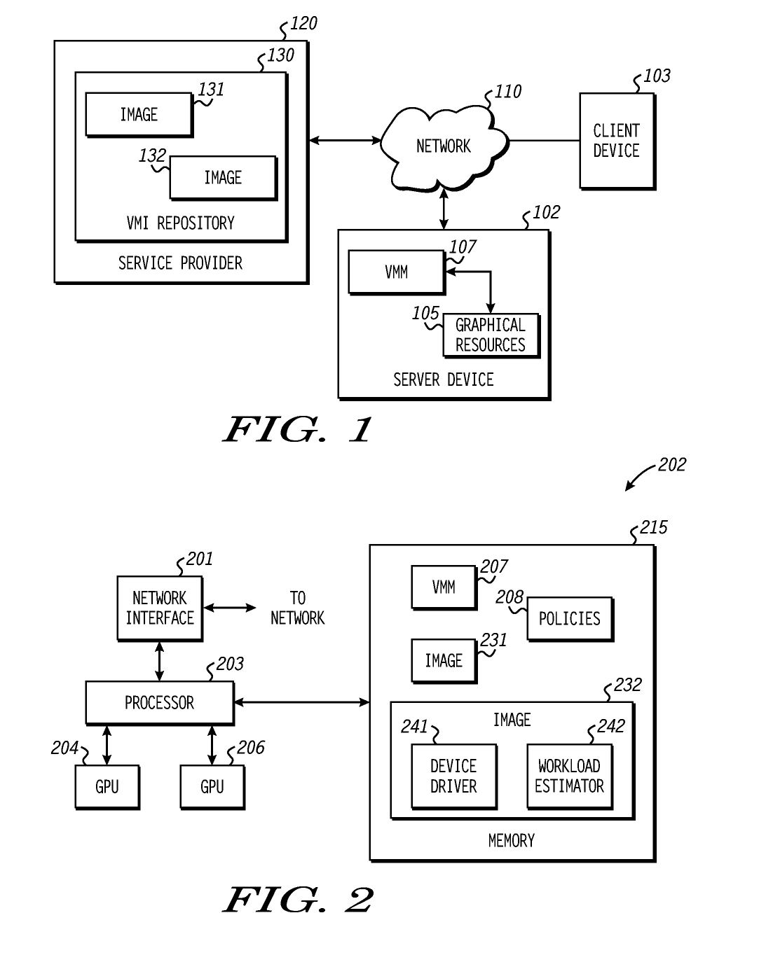

FIG. 1 illustrates a block diagram of a communication network 100 including a server device 102, a client device 103, and a service provider 120, each connected to a network 110. In the illustrated embodiment of FIG. 1, the network 110 is assumed to be a packet-switched network that provides a physical layer for communication of information between the server device 102 and the service provider 120. Further, in the illustrated embodiment the network 110 is assumed to be a wide area network such as the Internet. In other embodiments, the network 110 can also include a combination of networks, such as a combination of local and wide area networks.

The server device 102 is an information handling device configured to receive a virtual machine image (VMI) from the network 110 and run the virtual machine (VM) represented by the image. As used herein, a virtual machine refers to a software emulation of an information handling system, such as a computer. In one embodiment, the virtual machine emulates operation of a particular information handling system, such as a computer using a particular processor and chipset. A VM can be configured to executed software designed for a particular information handling system on a different information handling system for which the software was not designed. In addition, a virtual machine image is a set of information indicating a particular configuration of an associated virtual machine. Accordingly, the virtual machine image can indicate software applications, data files, hardware and software configurations, memory states, and other information to allow the virtual machine to emulate operation of the information handling system.

The client device 103 is an information handling system configured to communicate with the server device 102 via the network 110 to allow a user of the client device 103 to interact with a VM being at the server device 102 that executes a client application. The client device 103 thereby can provide a virtual desktop environment for the user. In particular, a user can access desktop environments represented by a particular VM executing at the server device 102 from different client devices. In addition, the user can select different VMs to execute at the server device 102 in order to interact with different desktop environments represented by the VM.

In one embodiment, the client device 103 is a thin-client device, whereby the client device is configured to interact with a VM implemented at the server device 102; however, the client device is not configured, based on information stored locally at the client device 103, to operate independently as a full-featured computer system. For example, the thin client may not locally store a full operating system or application software. In other embodiments, the client device 103 is a thick client, whereby the device stores a full operating system or other software that allows the device to operate as a full-featured computer system independent of interacting with a VM being executed at the server device 102. The full-featured computer system can be of the same type or of a different type than a VM accessed by client device 103.

In the illustrated embodiment, the server device 102 includes a virtual machine manager (VMM) 107 and a set of graphical resources 105. The VMM 107 is configured to provide an interface between VMs executing at the server device 102 and HARDWARE system resources of the server device 102. As used herein, a system resource is any resource, such as a memory resource, processor resource, or other hardware resource that is employed by the server device 102 to execute an assigned task. To illustrate, the VMM is configured to receive a request from a VM for a system resource and, in response, assign one or more system resources to respond to the request. For example, the VMM can receive a request from the VM to retrieve data associated with a memory address. In response, the VMM can communicate a read request to a memory module (not shown), of the server device 102, receive information in response to the read request, and provide the received information to the VM. In an embodiment, the VM is unaware of the particular system resources assigned by the VMM to perform a requested task.

In the course of assigning system resources, the VMM 107 can assign a portion of the graphical resources 117 to each VM being executed at the server device 102. As used herein, graphical resources refers to system resources dedicated to creating and manipulating information for visual display at the client device 103. Examples of graphical resources include framebuffer resources, graphical processor unit (GPU) resources, and the like.

The service provider 120 is configured to provide information and services in response to requests received from the network 110. As illustrated, the service provider 120 includes a VMI repository 130 to store a plurality of VMIs, including VMIs 131 and 132. The VMI repository 130 is configured to receive identification information from the network 110 and is configured to search the plurality of VMIs based on the identification information and select a set of VMIs associated with the identification information. The VMI repository 130 can be configured to provide option information associated with the selected set to the network 110, and to receive VMI selection information in response to providing the option information. In addition, the VMI repository 130 is configured to provide a VMI to the network 110 in response to the selection information.

In addition, each VMI can be associated with a different computing environment, intended function, or designated use. Thus, in one embodiment the VMIs 131 and 132 can be associated with a particular user, with each VMI associated with a different computing environment. For example, the VMI 131 can be associated with the user's personal or home computing environment, while the VMI 132 is associated with the work computing environment. Accordingly, the VMI 131 will store personal information, applications, machine configurations, and other information for the user's personal computer use, while the VMI 132 will store similar types of information for the user's work functions. In another embodiment, the VMI 131 can be associated with gaming functions while the VMI 132 is associated with multimedia processing functions. In this embodiment, the VMI 131 can store game applications, game information (e.g. saved games, character configuration information), and the like, while the VMI 132 includes multimedia processing applications (e.g. video editing applications, audio production applications), stored multimedia files, and the like.

In operation, the server device 102 requests VMI 131 and 132 from VMI repository 130. In response, VMI repository 130 communicates the requested images via the network 110. Server device 102 receives VMI 131 and 132, and executes a VM based on each image. In an embodiment, server device 102 can be a server device that concurrently executes each VM for different users of the client device 103. Thus, for example, one user can interact, via a client device such as client device 103 with a VM based on VMI 131, while a second user interacts with a VM based on VMI 132 via another client device.

During operation, VMM 107 can determine an amount of graphical processing workload for each VM being executed and, based on this determination, assign portions of the graphical resources 117 to each VM. The VMM 107 can thereby ensure, for example, that a VM requiring more graphical processing power are assigned more of the graphical resources 117, so the VM can operate efficiently. For example, VMI 131 can be configured to provide a user with a number of image processing applications, such as photo or video manipulation applications, which typically require a large number of graphical resources to operate efficiently. In contrast, VMI 132 can be configured to provide the user with word processing or spreadsheet applications, which typically do not require a large number of graphical resources. VMM 107 can assign portions of the graphical resources 115 to VMs associated with each of VMI 131 and 132 based on the estimated graphical processing workload for the VM, thereby allotting more resources to those VMs requiring more graphical resources.

FIG. 2 illustrates a particular embodiment of an information handling system 202, corresponding to a specific embodiment of the server device 102 of FIG. 1. Information handling system 202 includes a network interface 201, a processor 203, a memory 215, graphical processing units (GPUs) 204 and 206. Network interface 201 is connected to the network 110 (FIG. 1). Processor 203 is connected to GPUs 204 and 206, as well as memory 215.

Network interface 201 is configured to provide a physical and logical level interface for communications between the network 110 and the information handling system 202. Accordingly, network interface 201 can communicate requests for VMIs to the network 110, and communicate received VMIs to the processor 203. In addition, network interface 201 can communicate information, such as graphical image information, to one or more client devices, such as client device 103, via the network 110.

Processor 203 is a data processing device, such as a general purpose processor, configured to executed instructions in order to perform specified tasks. In the course of executing designated instructions, processor 203 can retrieve and store information at the memory 215, and provide configuration information and requests for graphical operations to the GPUs 204 and 206.

GPUs 204 and 206 are each configured to execute requests for graphical operations and, based on those operations; provide information for display at a client device. In the illustrated embodiment, GPUs 204 and 206 can each provide information for display. For example, GPUs 204 and 206 can provide frames for display at one client device in an interleaved fashion, providing for a continuous display of information at the client device. In other embodiments, GPUs 204 and 206 can be configured in a “master-slave” fashion, whereby one GPU (the “master”) provides information for display and the other (the “slave” performs tasks on behalf of the master, but does not directly provide information for display. In one embodiment, GPUs 204 and 206 are each physical graphical processors, video cards, or other physical systems. In another embodiment, one or both of GPUs 204 and 206 can be a virtual GPU. As used herein, a virtual GPU refers to a software emulation of a physical GPU. In some embodiments, GPU 204 can be a physical GPU while GPU 206 is a virtual GPU.

The memory 215 is a computer readable medium, such as volatile memory, flash memory, a hard disk, and the like, that stores VMM 207, corresponding to VMM 107 of FIG. 1. VMM 207 represents a set of computer instructions configured to manipulate processor 203 to implement various virtual machines based upon one or more of the methods disclosed herein.

In addition, memory 215 stores VMIs 231 and 232, corresponding to VMIs 131 and 132 of FIG. 1. The VMIs 131 and 132 can be retrieved from the VMI repository 130, as described above with respect to FIG. 1, and communicated to the memory 215 via the network interface 201 and processor 203. The memory 215 also stores a set of policies 208, which store information indicative of quality of service profiles for particular VMIs or classes of VMIs. In particular the policies 208 designate an amount of graphical resources that should be assigned to a VM, based on the VMI or class of VMI associated with a particular VM. In an embodiment, the amount of graphical resources can be designated in a relative fashion, indicating which VMIs or classes of VMIs are associated with VMs that should be assigned more resources relative to VMs associated with other VMIs or classes of VMIs. For example, policies 208 can indicate that VMs associated with VMIs targeted to multimedia applications should be assigned more graphical resources than VMs associated with VMIs targeted to web-browsing or word-processing applications. The policies 208 can also designate an amount of graphical resources based on a user, or class of user, requesting a particular VMI. The policies 208 can be programmable policies, and can therefore be set by a system administrator or other user in order to control quality of service for each VM.

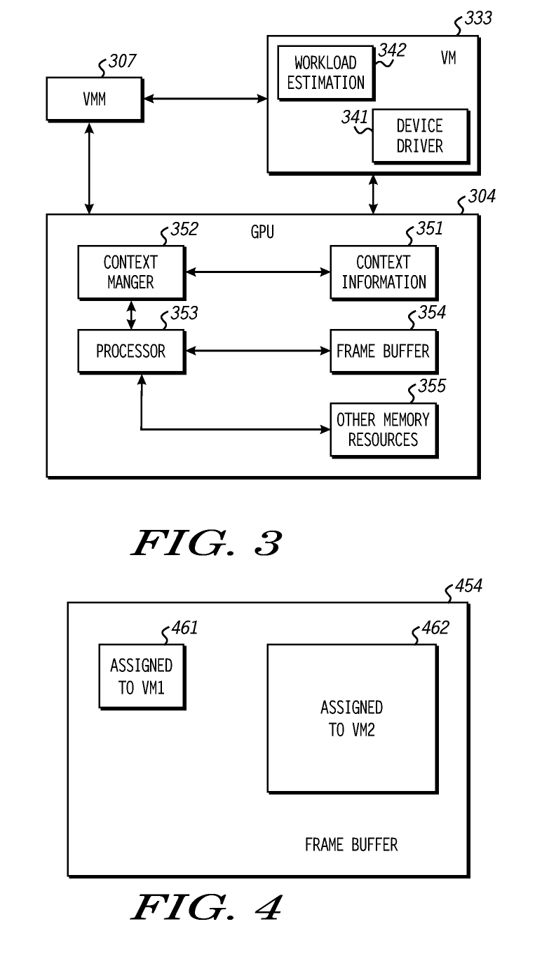

In operation, the processor 203 executes the VMM 207, as well as VMs associated with each of VMI 231 and 232. In the illustrated embodiment of FIG. 2, VMI 231 includes a workload estimator 242 and a device driver 241. In operation, device driver 241 can provide requests for graphical operations to the VMM 207, or directly to one or more of the GPUs 204 and 206. Workload estimator 242 can provide an indication of an estimated amount of workload for the VM associated with VMI 232. For example, workload estimator 242 can indicate a number of tasks expected to be requested by the VM for processor 203, GPU 204 or GPU 206. Workload estimator 242 can also provide an indication of an amount of memory space expected to be requested by the VM. Based on this information, and other estimated workload information, as well as the policies 208, VMM assigns a number of graphical resources available at GPU 204 and 206 to the VM. This can be better understood with reference to FIG. 3.

FIG. 3 depicts a block diagram illustrating additional details of portions of information handling system 202 according to one embodiment of the present disclosure. In particular, FIG. 3 illustrates GPU 304, corresponding to a specific embodiment of GPU 204 of FIG. 2, and VMM 307, corresponding to a specific embodiment of VMM 207. In the illustrated embodiment of FIG. 3, it is assumed that VMM 307 is being executed at processor 203. In addition, it is assumed that processor 203 is executing a VM 333 based on VMI 232 (FIG. 2). VM 333 and VMM 307 can both communicate with GPU 304.

GPU 304 includes a context manager 352, context information 351, a processor 353, a framebuffer 354, and other memory resources 355. The context manager 252 can access context information 351, and can communicate information to processor 353. Processor 353 is connected to framebuffer 354 and to the other memory resources 355.

Processor 353 is a data processor configured to receive requests for graphical operations and, based on those requests, create, manipulate and provide information for display to a frame buffer. In an embodiment, processor 353 is an application-specific integrated circuit (ASIC) designed to perform graphical operations more quickly than a general purpose processor 203 (FIG. 2).

Framebuffer 354 is a memory configured to store information for display at a client device. In an embodiment, the framebuffer 354 is configured to store the information as a set of frames, where each frame is associated with a single set of information to be displayed. In an embodiment, the framebuffer 209 can store frames associated with different client devices. Thus, framebuffer 354 can store frames associated with a first client device and frames associated with a second client device.

Other memory resources 355 include memory used by processor 353 to store information other than frame information stored at framebuffer 354. For example, in the course of creating a frame for display, the processor 353 can perform a number of calculations and other manipulations of graphical information. The other memory resources 355can include system memory used by the processor 353 to temporarily store results of the calculations and other manipulations in the course of creating one or more frames for storage at the framebuffer 354.

Context information 351 includes information indicating an amount of graphical resources at GPU 304 to be assigned to a particular VM, such as VM 333. Context information 351 can be stored in volatile memory, non-volatile memory, and the like. Context manager 352 is configured to access context information 351 and, based on the information, indicate to processor 353 how resources are to be assigned at GPU 304. Context manager 352 can be a hardware module, or a software routine that is executed by processor 353.

In operation, VM 333 executes workload estimator 342, which analyzes the workload associated with the VM. For example, workload estimator 342 can analyze the number of processor tasks requested by VM 333, the amount of memory resources requested by VM 333, and the like. Based on the analysis, workload estimator 342 communicates an estimated amount of workload associated with VM 333 to VMM 307. In an embodiment, the estimated amount of workload can be communicated by the device driver 341 to the VMM 307. In other words, VM 333 can employ the device driver 341 configured to communicate requests to GPU 304 to also communicate information to VMM 307.

Based on the estimated amount of workload received from each VM being executed at the information handling system 202, as well as the policies 208 (FIG. 2), the VMM 307 determines an amount of graphical resources to be assigned to each VM. In an embodiment, the VMM 307 can change the amount of graphical resources assigned to each VM over time, as estimated workload requirements for each VM change. The VMM 307 can thereby adapt to changes in graphical resource requirements at each VM.

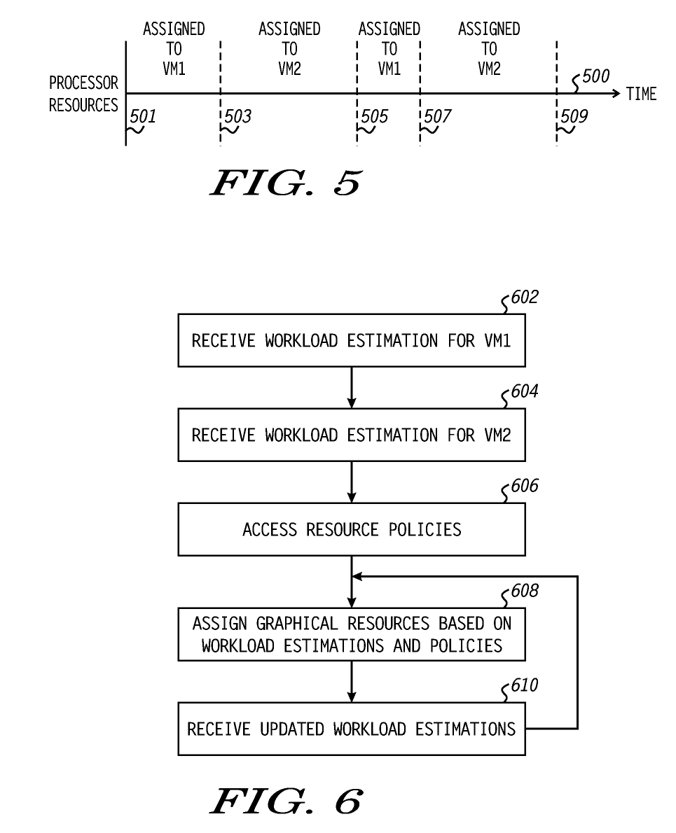

The VMM 307 communicates the amount of graphical resources assigned to each VM, such as VM 333, to GPU 304, which stores the information at context information 351. Based on this information, context manage 352 communicates control information to processor 353. Based on the control information, processor 353 assigns graphical resources to each VM. Examples of graphical resources that can be assigned include memory space at framebuffer 354, memory space at one or more of the other memory resources 355, and processor resources at processor 353. These can be better understood with reference to FIGS. 4 and 5.

FIG. 4 illustrates a particular embodiment of a framebuffer 454, corresponding to framebuffer 354 of FIG. 3. Framebuffer 454 includes a portion 461 and a larger portion 462. It is assumed for purposes of discussion that the portion 462 can store more frames for display that portion 461. In the illustrated example of FIG. 4, processor 353 has assigned portion 461 for frames associated with a virtual machine labeled “VM1”, and has assigned portion 462 for frames associated with a virtual machine labeled “VM2.” It is assumed that frames associated with a particular VM can only be stored in the framebuffer portion associated with that VM. In other words, in the illustrated example of FIG. 4 processor 353 has apportioned the available memory space of framebuffer 454 so that there is more space available to store frames associated with VM2 than VM1. This allows VM2 to display information more efficiently than VM1. For example, the greater amount of space available for VM2 at framebuffer 454 can allow VM2 to display information at a greater frame rate than VM1.

It will be appreciated that, as VMM 307 changes the amount of resources assigned to each VM, processor 353 can change the amount of framebuffer space assigned to each VM. Thus, the relative sizes of portions 461 and 462 can change over time, to reflect the changing graphical needs of VM1 and VM2, respectively.

It will further be appreciated that the amount of the other memory resources 355 can be apportioned among VMs in similar fashion to that described with respect to FIG. 4. Thus, for example, portions of system memory can be assigned to each VM, with each portion having a different size according to the amount of graphical resources assigned to each VM.

FIG. 5 illustrates a diagram depicting the assignment of resources at the processor 353 over a designated period of time according to one embodiment of the present disclosure. For purposes of discussion, it is assumed that processor 353 is a single core device that can execute tasks on behalf of only one VM at a time. In other embodiments, processor 353 can be a multi-core processor, where each core executes tasks on behalf of only one VM at a time. In the case of a multi-core processor, FIG. 5 illustrates the assignment of tasks at one processor core.

Axis 500 illustrated at FIG. 5 represents time. Accordingly, FIG. 5 illustrates the relative amount of time the processor 353 is assigned to execute tasks requested by VM1 or VM2. For example, between time 501 and time 503, and between time 505 and time 507, processor 353 is assigned to execute tasks requested of VM1. Between time 503 and 505, and between time 507 and 509, processor 353 is assigned to execute tasks requested by VM2. The relative amount of time assigned to each VM can be set by the context manager 352 based on the context information 351. In an embodiment, the amount of time can be indicated by a percentage for each VM. For example, the context manager 351 can indicate that 40 percent of processor time will be assigned for VM1 and 60 percent assigned for VM2. Processor 353 can then ensure that, for a specified unit of time, 60 percent of that time is dedicated by processor 353 to executing tasks requested by VM2 and 40 percent of that time is dedicated by processor 353 to executing tasks requested by VM1. In one embodiment, processor 353 can organize tasks requested by each VM into program threads, and switch between threads associated with each VM so that processor 353 executes tasks associated with VM1 and VM2 for the indicated amount of time.

FIG. 6 illustrates a flow diagram of a method of assigning graphical resources for a plurality of VMs in accordance with one embodiment of the present disclosure. At block 602, VMM 207receives information indicative of an estimated workload for a first VM, designated “VM1.” At block 604, VMM 207receives information indicative of an estimated workload for a second VM, designated “VM2.”

At block 606, VMM 207 accesses policies 208 to determine a set of graphical resource policies associated with each of VM1 and VM2. In an embodiment, each of VM1 and VM2 are associated with a different class of VM. In one embodiment, a class of VM refers to one or more VMs designated to be part of the class based on a common characteristic between the VMs. For example, a class of VMs can be associated with a common intended use for each VM in the class, a common type of operating system, a common type of hardware to be emulated by the VMM 207, and the like. In another embodiment, VMs can be assigned to a designated class by a system administrator or other user. The policies 208 can indicate an amount of graphical resources to be assigned to each of VM1 and VM2 based on their respective associated classes.

In another embodiment, each of VM1 and VM2 can be associated with a different user, where each user is associated with a different class of users. In one embodiment, a class of users refers to one or more users that share a common characteristic. For example, users can be grouped into different classes based on an occupation type, security level, job title, and the like. The policies 208 can indicate an amount of graphical resources to be assigned to each of VM1 and VM2 based on their respective associated classes.

In still another embodiment, each of VM1 and VM2 are associated with a different application type associated with an application being executed at the VM. In one embodiment, an application type indicates a specified use of the application. Examples of application types can include image manipulation, word processing, games, and the like. In another embodiment, application types can be assigned to a designated application by a system administrator or other user. The policies 208 can indicate an amount of graphical resources to be assigned to each of VM1 and VM2 based on their respective associated application type.

At block 608, the VMM 207 provides information to the GPUs 204 and 206 to assign graphical resources for VM1 and VM2 at each unit based on the estimated workload information and the policies 208. For example, in one embodiment, the policies 208 can indicate a maximum amount of resources that can be assigned to VM1. Accordingly, VMM 207 will assign resources to VM1 based on the associated estimated workload information, up to the maximum amount indicated by the policies 208.

At block 610, updated workload estimation information is received for one or more of VM1 and VM2. Accordingly, the method returns to block 608 and VMM 207 can reassign graphical resources based on the updated workload information. Thus, VMM 207 can change the amount of graphical resources assigned to each of VM1 and VM2 over type, based on the changing amount of workload at each VM. For example, at a first time, VM1 can be executing software that demands a relatively small amount of graphical resources, such as a word processor. Accordingly, at the first time, the VMM 207 receives a workload estimation for VM1 that is relatively small. In response, at block 608, the VMM 207 can assign a relatively small amount of graphical resources at the GPUs 204 and 206 to VM1. Later, a user of VM1 can start an image editing program that requires a relatively high amount of graphical resources. Accordingly, at a second time (indicated by block 610), VMM 207 receives an updated workload estimate for VM1 indicating a higher workload estimation. In response, at block 608, VMM 207 can assign additional resources to VM1.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A method, comprising:
receiving first information indicative of a first estimated workload associated with a first virtual machine;
receiving second information indicative of a second estimated workload associated with a second virtual machine;
assigning a first set of graphical resources associated with a graphic processor to the first virtual machine based on the first information and the second information; and
assigning a second set of graphical resources associated with the graphics processor to the second virtual machine based on the first information and the second information.

2. The method of claim 1, wherein the first information indicates an amount of data processor resources requested by the first virtual machine.

3. The method of claim 1, wherein the first information indicates an amount of memory used by the first virtual machine.

4. The method of claim 1, wherein receiving the first information comprises receiving the first information at a virtual machine manager from a first graphics driver.

5. The method of claim 1, wherein assigning the first set of graphical resources comprises assigning the first set of graphical resources based on a first programmable policy associated with the first virtual machine.

6. The method of claim 5, wherein assigning the first set of graphical resources comprises:
determining a virtual machine class associated with the first virtual machine; and
determining the first set of graphical resources based on the virtual machine class and the first programmable policy.

7. The method of claim 5, wherein assigning the first set of graphical resources comprises:
determining a user class associated with the first virtual machine; and
determining the first set of graphical resources based on the user class type and the first programmable policy.

8. The method of claim 5, wherein assigning the first set of graphical resources comprises:
determining an application type associated with an application executing at the first virtual machine; and
determining the first set of graphical resources based on the application type and the first programmable policy.

9. The method of claim 5, wherein assigning the second set of graphical resources comprises assigning the second set of graphical resources based on the first programmable policy.

10. The method of claim 5, wherein assigning the second set of graphical resources comprises assigning the second set of graphical resources based on a second programmable policy associated with the second virtual machine.

11. The method of claim 1, wherein assigning the first set of graphical resources comprises:
determining a first set of tasks associated with the first virtual machine; and
scheduling execution of the first set of requests at the plurality of graphics processors for a first period of time based on the first information.

12. The method of claim 1, wherein assigning the first set of graphical resources comprises assigning a first portion of framebuffer space associated with the plurality of graphics processors based on the first information.

13. The method of claim 1, wherein assigning the first set of graphical resources comprises assigning the first set of graphical resources at a first time, and further comprising:
receiving third information indicative of a third estimated workload associated with the first virtual machine; and
assigning a third set of graphical resources associated with the graphics processor to the first virtual machine at a third time, the third set of graphical resources based on the third information.

14. The method of claim 1, wherein the graphics processor is a virtual graphics processor.

15. A method, comprising:
receiving at a first time first information indicative of a first amount of system resources requested by a first virtual machine;
communicating first display information for the first virtual machine based on a first set of graphical resources, the first set of graphical resources based on the first information;
receiving at a second time second information indicative of a second amount of system resources requested by a first virtual machine; and
communicating second display information for the first virtual machine based on a second set of graphical resources, the second set of graphical resources based on the second information.

16. The method of claim 15, wherein the first set of graphical resources comprises a first amount of memory resources and the second set of graphical resources comprises a second amount of memory resources.

17. The method of claim 15, wherein the first set of graphical resources comprises a first amount of processor resources and the second set of graphical resources comprises a second amount of processor resources.

18. The method of claim 15, wherein the first set of graphical resources and the second set of graphical resources are each based on a graphical resource policy associated with the first virtual machine.

19. A computer readable medium physically embodying a program of instructions to manipulate a processor, the program of instructions comprising instructions to:
receive first information indicative of a first estimated workload associated with a first virtual machine;
receive second information indicative of a second estimated workload associated with a second virtual machine;
assign a first set of graphical resources associated with a plurality of graphics processors to the first virtual machine based on the first information and the second information; and
assign a second set of graphical resources associated with the plurality of graphics processors to the second virtual machine based on the first information and the second information.

20. The computer readable medium of claim 19, wherein the instructions to assign the first set of graphical resources comprise instructions to:
determine a first set of tasks associated with the first virtual machine; and
schedule execution of the first set of requests at the plurality of graphics processors for a first period of time based on the first information.
